(19) United States
(12) Patent Application Publication
(10) Pub. No.: US 2005/0037111 A1
(43) Pub. Date: Feb. 17, 2005

(54) Ice confection and its manufacturing process

(75) Inventors: Mark John Berry, Bedford (GB); Andrew Richard Cox, Bedford (GB); Robert Daniel Keenan, Bedford (GB); Patricia Jill Quail, Bedford (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Good Humor-Breyers Ice Cream, Division of Conopco, Inc.

(21) Appl. No.: 10/917,072

(22) Filed: Aug. 12, 2004

(30) Foreign Application Priority Data
Aug. 12, 2003 (EP) 03254986.7

(51) Int. Cl. A23G 1/00

(52) U.S. Cl. 426/100

(57) ABSTRACT

An ice confection containing; i) at least 2% by wt. fat; ii) at least 10% by wt. of a sugar or sugars; and iii) protein, which is present at a level of less than 2% by weight; wherein some or all of the fat and protein are present as oil bodies.

### TECHNICAL FIELD OF THE INVENTION

The invention relates to ice confections and their manufacturing process, in particular to low cost ice confections which contain oil bodies.

### BACKGROUND TO THE INVENTION

Frozen confections or “ice confections” such as ice cream are well known. However, standard ice cream is too expensive for many consumers to eat every day. Also, the presence of high levels of saturated fat, common to many ice confections, is unattractive to many consumers from a health perspective for an “every day” product.

Typically ice cream will contain, by weight of the composition, 10-18% fat, 7-11.5% milk solids not fat (MSNF), 15-18% sugars and other ingredients such as stabilisers, emulsifiers and flavourings (Ice Cream, Fourth Edition by W. S. Arbuckle, Pub. Van Nostrand Reinhold, New York, 1986, p 381). However, the precise composition of ice cream products varies from market to market. One reason for this is that the legal definition of ice cream (in terms of ingredients and formulation) differs from country to country.

A significant portion of the overall cost of these formulations is the expense of the ingredients, and a particularly high percentage of this cost is the cost of MSNF. MSNF contains casein micelles and whey proteins which contribute to the stabilisation of the fat emulsion and the air phase; MSNF also contains lactose. It is the stabilisation of the air phase which makes it possible for ice cream to have a typical overrun of around 100% and, as a result, a light texture.

The stabilisation of the fat emulsion is important as it is the presence of this emulsion which delivers the ‘creamy’ mouth feel characteristic of ice cream products.

To reduce the cost of an ice cream confection, it would therefore be desirable to produce confections which contain less MSNF, or in which this ingredient is entirely absent. In addition, for every day confections it would be advantageous if the product could include polyunsaturated fats, which are perceived as a ‘healthy’ alternative to the saturated fats commonly found in ice confection products.

Cheaper alternatives to ice cream include milk ices and water ices. Milk ices typically contain around 2 wt % fat and 3-5 wt % MSNF. However, as a result, the overrun of these products is typically only about 10-30%; therefore they do not have a light texture. Water ices provide an even cheaper ice confection product, typically containing none of the costly fat or MSNF. They are unaerated, and hence typically have an overrun of 10% or less; they are neither creamy nor light in texture.

Schlegel et al. (EP 1 180 330) describes a low cost ice confection where the MSNF is replaced with starch to reduce the cost of the product without loss of product creaminess. The ice confection comprises fatty matter, sweetening agent, MSNF, water and starch, and the total amount of starch and MSNF is in the range 2.5 wt % to 18 wt %.

“Ice cream” (i.e. ice confections claiming to have some of the properties of traditional ice cream) compositions containing no MSNF are also known in the art. Many of these formulations are aimed at providing ‘ingredient free’ products aimed at consumers with food intolerances or allergies. For example, Minoru et al. (JP 11 253 104) discloses a protein free “ice cream” comprising butter oil as a lipid source; a saccharide sweetener and melting point depressant; and a polysaccharide. The polysaccharide is present in this composition in place of protein.

Gonsalves et al. (U.S. Pat. No. 5,384,145) relates to low fat frozen toppings which are non-dairy, aerated, exhibit a high over run (greater than 250%) and have a high solids content (38-50 wt %). These compositions comprise 8-15 wt % fat. This formulation is stabilised through precise control of the ratio of emulsifier to fat and water soluble protein.

Riviere et al. (WO 97/30600) relates to a soft frozen dessert comprising a fat with a low freezing point (sunflower oil); dairy protein, sugars and stabilisers.

None of the documents above relate to an ice confection which is both low cost and which will be perceived by the general consumer as a ‘healthy’ alternative to other ice confections. Moreover, none relate to an ice confection that has been designed to appeal as an “everyday” product by virtue of both its low cost and the presence of a healthy oil phase, containing for example unsaturated fats, anti-oxidants or vitamins such as vitamin E. Oil bodies are a low cost alternative to traditional ingredients, in part because they are pre-emulsified. This eliminates the need for an emulsification step during processing and reduces or eliminates the amount of MSNF (or other protein ingredient) that needs to be added to the formulation. In addition, the fats found in oil bodies tend to be unsaturated, and often contain vitamins which are not present in typical ‘fat’ mixtures. For example, oil bodies extracted from sunflower seeds contain oil which is about 70% polyunsaturated, and also vitamin E. Therefore, the addition of oil bodies to ice confection products also provides a health aspect which has not been offered before. The resultant ice confection products also have a highly acceptable taste.

Methods for the extraction of oil bodies from a range of plant seeds are known in the art. For example, Deckers et al. (U.S. Pat. No. 6,146,645) concerns the extraction of oil bodies from plant seeds, for example sunflower seeds, and the use of oil bodies in a range of industries including the food industry. Ice cream compositions are said to be a possible end utility for the oil bodies so produced, but no further details are provided. The contents of this document, particularly in as far they relate to the detection, nature of, preparation and processing of oil bodies are specifically incorporated herein by reference.

Wakabayashi et al. (EP 0 883 997) discusses the extraction of lipid/protein complexes (oil bodies) from seeds. Again, the contents of this document, particularly in as far they relate to the detection, nature of, preparation and processing of oil bodies are specifically incorporated herein by reference.

Methods for the extraction of lipid/protein isolates from a range of other plant sources and their use in ice confections are also known in the art. It is possible that some of these extracts or isolates contain oil bodies. For example, Juillerat et al. (U.S. Pat. No. 6,383,550) discloses the extraction of lipid and protein extracts from fruit kernels and their use in food products such as ice cream. It is possible that this extract would contain oil bodies. However, the extract described therein has a lipid/protein ratio of 0.05 to 3.5. Only one example of an ice cream product is described (example 7), and this is thought to have a protein content of approximately 4%.

Goodnight Jr et al. (U.S. Pat. No. 4,088,795) discloses the removal of soluble carbohydrate from an oil seed-lipid containing emulsion in order that the emulsion, when used in food products, is more easily digested.

There continues, however, to be a need for ‘every day’ ice confections which are inexpensive and relatively healthy. To achieve this it is desirable to develop an ice confection which has some or all of the characteristics of ice cream, but which contains reduced amounts of MSNF, or perhaps in some embodiments no MSNF at all; and contains low amounts of (or no) other protein ingredients. Moreover, the total protein content in the ice confection should be kept to a workable minimum so that the ingredient costs are low.

The applicant has found that the use of oil bodies in ice confection products can provide this.

In a preferred aspect, the use of oil bodies in ice confection compositions containing an aerating agent can produce ice confection products which have a light texture and creamy mouth feel, but which contain reduced levels of or even no MSNF.

The products of the invention typically have a low total solids content, and provide health benefits as oil bodies typically comprise polyunsaturated oils, such as are found for example in sunflower oil, which are healthier than the saturated fats often used in frozen confectionery products. In addition, oil bodies are less refined than the purified oil on which they are based, allowing desirable components such as vitamin E to be present in the final formulation.

One advantageous aspect of the invention is therefore the production of an ice confection which contains reduced amounts of MSNF (e.g. at most 5% by weight of the composition), or no MSNF at all.

A further advantage is to be able to produce frozen aerated confectionery products which improve on deficiencies of prior art products, and which furthermore may be both cheaper to produce and healthier.

### BRIEF DESCRIPTION OF THE INVENTION

It is a first object of the present invention to provide an ice confection containing;
i) at least 2% by wt. fat;
ii) at least 10% by wt. of a sugar or sugars; and
iii) proteins, present at a level of less than 2%;
   wherein some or all of the fat and protein are present as oil bodies.

The presence of oil bodies in the composition reduces or eliminates the need to include MSNF, as the oil bodies are pre-emulsified. The resultant products are typically much cheaper to manufacture. The presence of non-oil body fats require the addition of a separate emulsifying agent so that a product of acceptable texture may be produced.

In a preferred embodiment, an aerating agent is added to the formulation so that an aerated ice confection can be produced. In this embodiment, the overrun of the composition is at least 30%, preferably at least 50%, more preferably in the range 75% to 150%. Preferably the overrun is no more than 200%. However for certain envisaged ice confection product forms, the overrun can be up to 30%.

More preferably the aerating agent is a polyglycerol ester of fatty acids. In another more preferred embodiment, the aerating agent comprises monoglycerides.

More preferably also, some of the protein is oleosin. Even more preferably, some of the protein is sunflower oleosin.

In another more preferred embodiment of the invention the oil bodies are derived from a source selected from the group consisting of sunflower, rapeseed, soybean, oil palm, cotton seed, ground nut, castor, safflower, mustard, coriander, squash, linseed, brazil nut, jojoba, maize, sesame, chick pea, avocado, or any mixture thereof. Even more preferably, the oil bodies are derived from a source selected from the group consisting of sunflower, soybean, avocado or rapeseed or any mixture thereof. Even more preferably the oil bodies are derived from sunflower.

Preferably also, the oil bodies are present at a level of 0.5% to 20% by weight of the ice confection. More preferably the oil bodies are present at a level of 2% to 10% by weight of the ice confection.

Preferably also, proteins are present at a level of at least 0.2% by weight of the ice confection. More preferably, proteins arepresent at a level of at least 0.5% by weight of the ice confection.

Preferably also, fat is present at a level of 2% to 10% by weight of the ice confection. More preferably, fat is present at a level of 2% to 6% by weight of the ice confection.

Preferably also, sugar is present at a level of 10% to 20% by weight of the ice confection.

Preferably, the ice confection additionally comprises a stabilizer. More preferably, the stabilizer is present at a level of 0.05% to 1% by weight of the ice confection. More preferably also, the stabilizer is selected from the group consisting of locust bean gum, kappa carrageenan or guar gum, or any mixture thereof.

Preferably also, the ice confection additionally comprises a fruit puree.

It is a second object of the present invention to provide a method for preparing an ice confection including the steps of;
a) preparing an oil body preparation;
b) mixing non-oil body components together at elevated temperature;
c) adding the oil body preparation;
d) pasteurisation;
e) cooling;
f) aeration; and
g) freezing the confection.

In a preferred embodiment, the aerating agent is added separately from the other non-oil body components after cooling and prior to aeration.

### DETAILED DESCRIPTION OF THE INVENTION

The overrun of an ice cream (or other aerated ice confection) is defined as the increase in volume of the ice cream over the volume of the unaerated and unfrozen mix due to the incorporation of air and the formation of ice. This is expressed as a percentage of the volume of the mix. The percentage overrun can be calculated by weight using the formula given in “Ice Cream, Fourth Edition by W. S. Arbuckle, Pub. Van Nostrand Reinhold, New York, 1986, p 187.”

$$overrun \% = \frac{weight of 1 gal mix - weight of 1 gal ice cream}{weight of 1 gal ice cream}$$

This formula uses weight per gallon, but it is equally correct to use the weight of any other volume, so long as the same measure is used throughout the calculations. The important quantity in these calculations is the density.

The formula can therefore be rewritten as:

$$overrun \% = \frac{density of mix - density of ice cream}{density of ice cream} \times 100$$

Overrun can be determined most accurately at the point of manufacture as described below. However, where this is not possible overrun can be estimated using the Archimedes' principle. It is understood that when a body is added to a volume of water, the increase in weight is equal to the upthrust and hence weight of water displaced. Taking the density of water as 1 gcm⁻³, the weight of water displaced is used to determine the volume of water displaced and thus the volume of ice cream immersed in the beaker. From the mass and volume of the product, the density of the ice cream can be calculated.

With the exception of percentages cited in relation to the overrun of the composition, all percentages, unless otherwise stated refer to the approximate percentage by weight of the total composition.

Compositions according to the invention have been found to show improvements on prior products; in particular they are cheaper to make, and may be healthier than earlier products. They may also provide benefits to allergy sufferers as it is possible that these products will be ‘dairy free’. They may be cheaper to manufacture as the emulsification/homogenisation step is not essential due to the presence of pre-emulsified oil-bodies.

Oil bodies have been previously described and defined in the art. For instance, Deckers et al. (U.S. Pat. No. 6,146,645) writes as follows: “In the seeds of oilseed crops, such as soy bean, rapeseed, sunflower and palm, the water insoluble oil fraction is stored in discrete subcellular structures variously known in the art as oil bodies, oleosomes, lipid bodies or spheresomes. Besides a mixture of oils (triacylglycerides*) which chemically are defined as glycerol esters of fatty acids, oil bodies comprise phospholipids and a number of associated proteins, collectively termed oil body proteins. From a structural point of view, oil bodies are considered to be a triacylglyceride matrix encapsulated by a monolayer of phospholipids in which oil body proteins are embedded”.

*More usually known as triacylglycerols (TAGs) or fatty acid triglycerides.

The term ‘oil body preparation’ as used herein refers to the product of a process of extraction from a natural source, for example as in Example 1 below.

The term ‘oil body’ as used herein refers to the lipid-protein complex present in an oil body preparation. Moreover, where water is present in the preparation an allowance is made when calculating the mass of oil body added to an ice confection (for more details refer to examples).

Therefore the terms ‘oil bodies’ and ‘oil body preparation’ exclude the un-processed seeds.

Oil bodies suitable for use in the invention include those derived from sunflower, rapeseed, soybean, oil palm, cotton seed, ground nut, castor, safflower, mustard, coriander, squash, linseed, brazil nut, jojoba, maize, sesame, chick pea, avocado, or other sources containing similar amounts of protein and oil as would be obvious to the skilled person. In some embodiments, conveniently the oil body is derived from oil crop or vegetable (e.g. non-fruit) sources. In other embodiments, preferably the oil bodies of the invention are derived from sunflower seeds, soybean, avocado or rapeseed; most preferably, the oil bodies are derived from sunflower seeds.

Preferably, the oil bodies used in this invention have an oil/protein ratio (=lipid/protein ratio) by weight of greater than 3.5, and preferably less than 20.

The oil bodies will typically be present in the range 0.5-20 wt % of the composition, preferably in the range 2-10 wt %.

The protein component of the oil body will comprise at most 2%, preferably no more than 1% of the total composition. Protein will always be present in the ice compositions of the invention. Typically protein will be present in the composition at a level of at least 0.2%, more often at a level of at least 0.5% or 0.6% of the composition.

The fat component of the oil body will typically comprise at least 0.5 wt %, preferably 2-10 wt %, most preferably 2-6 wt % of the total composition.

Abundant oil body-associated proteins in the oil bodies as used in the invention are oleosins [A. H. C. Huang (1992) Annu Rev Plant Physiol Plant Mol Biol 43: 177-200]. Oleosins are relatively small (15-25 kD) amphipathic proteins [D. J. Murphy (1993) INFORM Vol 4 no. 8 p922]. Sequence information derived from different oleosins shows a strong homology within the central hydrophobic region, but very little similarity in the other two domains (Murphy, 1993). Oleosins may play a role in the stabilisation of the emulsions formed by oil bodies.

The presence of oil bodies can be detected in ice confections for example by the presence of oleosin protein. This is usually not present in refined oil source, for example sunflower oil. Methods for doing this are described below. Methods suitable for detecting the presence of triacylglycerols and other components that are characteristic of sunflower oil are also known.

Detection of Oleosin by Amino Acid Sequencing

McCarthy et al. (WO 01/36648) relates to recombinant genes which code for oleosin proteins found in cacao. The genes are used to manufacture emulsifiers, encapsulating agents and flavour components which may be useful in, among others, the food industry.

Amino acid sequences for oleosins from sunflower seeds and other oil seeds have been published and are available through sequence databases such as SwissProt and PIR (1). The sequences of oleosins from different species are related, in particular the central, hydrophobic domain is the region most conserved between species (2). Therefore, the oleosin protein can be identified by amino acid sequencing. Fragments of amino acid sequence obtained from the product (as described below) can be compared with the published sequences using database searching and sequence comparison facilities that are well-known in the art, such as ExPasy or SRS. If the stretches of sequence from the product closely match a published sequence, it indicates that oleosin from that oil seed is present in the product.

The protein component of an ice cream product can be separated from the other ingredients by melting the ice cream, diluting with water and carrying out a cold acetone precipitation. Following centrifugation the supernatant is discarded leaving the pelleted protein material. After drying off traces of acetone, the protein is re-solubilised into SDS sample buffer and prepared for SDS-PAGE (Polyacrylamide gel electrophoresis) by heating at 60° C. for 10 minutes or boiling for 1-2 minutes. The sample can then be run on SDS-PAGE alongside molecular weight standards, and the protein bands visualised with a stain such as coomassie blue. Using this procedure, two oleosin protein bands are typically seen. These bands correspond to the two oleosin isomers (approximate molecular weights 19.5 kD and 20.5 kD).

As the oleosin proteins are blocked to N-terminal sequencing (3), the protein bands are digested using an in-gel digestion technique and a suitable proteolytic enzyme such as trypsin or endoproteinase Lys-C. The protein fragments are then separated from each other using reverse phase chromatography, and the individual fragments sequenced using standard protein sequencing equipment. The short pieces of internal amino acid sequence thus obtained are compared with the published oleosin protein sequences as described above.

A general review article describing commonly used methods for preparing proteins for sequencing, including the strategies outlined above can be found in ref. (4).
1. Examples of sunflower seed oleosin sequences include the following accession numbers: SwissProt P29529 and PIR S70453.
2. Napier J. A., Beadoin F., Tatham A. S., Alexander L. G., Shewry P. R. (2001) Adv. in Bot. Res. 35 111-138.
3. Millichip M., Tatham A. S., Jackson F., Griffiths G., Shewry P. R., Stobart A. K. (1996) Biochem. J. 314 333-337.
4. Patterson S. D., (1994) Anal. Biochem. 221 1-15.
   Detection of Oil Bodies by Specific Antibodies

Antibodies specific for oleosin are known in the art [S. S. K. Tai et al. (2002) Biosci. Biotechnol. Biochem. 66 (10) 2146-2153]. These can be used to detect oil bodies in an ice confection. First the ice confection is allowed to melt and then the oil bodies are recovered by centrifugation as described above. Then a small sample of the oil bodies is suspended and diluted in water or aqueous buffer and visualised by immuno-fluorescent microscopy using the oleosin-specific antibody and staining reagents and procedures that are well known.

Detection of TAG and Other Components that are Characteristic of Sunflower Oil

Triacylglycerol (TAG) profiles for sunflower oil are easily determined by GC analysis. In addition, phospholipid (PL) profiles can be determined using HPLC. The levels of sterols, triterpene alcohols and tocopherols which are found in sunflower oil can all be determined by GC/HPLC and with Mass Spectrometry detection.

Useful references include:
1. For data on sunflower oil for fatty acids/triglycerides/PL/minor components: Lipid Handbook by F. D. Gunstone, J. Harwood and F. B. Padley, Pub. Chapman and Hall, 1986, Chap. 3.3, 35, p 101.
2. Also for sunflower oil fatty acid profiles: Codex Alimentarius Commission, Codex Committee on oils and fats.
3. For the determination of seed oil content and fatty acid composition in sunflower oil through the analysis of intact seeds, husked seeds, meal and oil by near IR reflectance spectroscopy: Perez-Vich B., Velasco L., Fernandez-Martinez J. M., J. Am. Oil Chem. Soc., 75 (5), 547-555.
4. For Phospholipid (PL) Profiles: Chapman G. W., J. Am. Oil Chem. Soc., 59, 299.
5. For sterols/triterpene alcohols and tocopherols: Sterols are found in the Lipid Handbook by F. D. Gunstone, J. Harwood and F. B. Padley, Pub. Chapman and Hall, 1986, Table 3.163 (adapted from Itoh et al. J. Am. Oil Chem. Soc. 1973). Tocopherols may be found in the Lipid Handbook table 3.167, p 129. Or in Analysis of oilseeds, fats and fatty foods, Elsevier, London, p 315

Proteins which may also be present in the inventive composition included skimmed milk proteins, soy protein, wheat protein, barley protein, lupin protein and mixtures thereof. Preferably any additional protein (i.e. not associated with oil bodies) will not comprise more than about 1 wt % of the composition.

The sugar of the invention will typically be a mono-, di-, or oligo-saccharide or sugar alcohol for instance, sucrose, dextrose, glucose, purified lactose, lactose monohydrate, glucose syrup, invert sugar, corn syrup, fructose or mixtures thereof. Where greater freezing point depression is required, so that the ice confection produced is softer, lower molecular weight molecules such as fructose may be selected. Preferably a blend of sugars is used, more preferably one of the sugars is sucrose. The sugar must be present in at least 10 wt %, preferably 10-₂₀ wt %, most preferably 12-18 wt % of the composition.

Method for Evaluating Candidate Aerating Agents

When the ice confection product is aerated, a suitable aerating agent (also known as a foaming agent) is required. Aerating agents suitable for the invention need to be both effective at aerating (i.e. they are active at low concentrations) and compatible with maintaining the integrity of the oil body structure. This combination of properties is thought to be a new technical requirement, and therefore it is not possible to use existing methodologies to define aerating agents that are suitable. A method for determining whether an aerating is suitable is described below.

Candidate aerating agents can be readily tested for suitability by making up a range of base mixes consisting of:

| | |
|---|---|
| Sucrose (Tate & Lyle) | 18% |
| Guar gum (Willy Benecke) | 0.3% |
| Oil bodies (Sunflower seed source)* | 1-5% |
| | (1% and 5% |
| | should be tried) |
| Candidate aerating agent | 0.05-1% |
| | (0.05%, 0.2%, |
| | 0.5%, and 1% |
| | should be tried) |
| Water (de-ionised) | to 100% |

*Made by the method of Example 1

Eight candidate formulations are thus assessed.

1-2 litres of each mix is made up in water at 60-70° C., the oil body preparation is added last. Then the mix is heated to 80° C. and the oil body preparation is dispersed using a Silverson L4R homogeniser. The Pasteurised oil body mix is then cooled to 4° C. Aeration (i.e. “whipping”) is carried out using a Hobart mixer (Hobart corp. model N50 CE) using 1-2 litres of mix and with the mixer set on full speed. Overrun is monitored by making a single measurement every 30 seconds using the overrun cup method (see section on methods for determining overrun). Aeration is continued until an overrun of 100% is reached or until the overrun stops increasing, whichever is sooner.

Aerating agents suitable for the invention produce an overrun of at least 30% in at least one of the mixes. The aerated mix is then poured into stainless steel moulds and frozen at −18° C. in a glycol bath. After freezing, the moulds are immersed in warm water (25° C.-30° C.) to release the frozen products from the moulds. The overrun is measured using the Archimedes' method (see section on methods for determining overrun). Aerating agents suitable for the invention produce an overrun of at least 30% in at least one of the frozen products.

An examples of a suitable and preferred aerating agent is PGE 55 (a polyglycerol ester of fatty acids, available from Danisco), known as food ingredient E475 in the EU. Preferably, the PGE will be present in the range 0.2-1 wt %, more preferably 0.5-1 wt % of the composition in aerated products. Another example of a suitable and preferred aerating agent is Myverol 18-04K (a distilled 95% monoglyceride prepared from vegetable oils, available from Quest International). Other sources of monoglyceride provide aerating agents suitable for the invention. Preferably the monoglyceride is present in the range 0.2-1 wt %, more preferably 0.5-1 wt %. The term “monoglyceride” as used herein means an ester of glycerol with one fatty acid molecule.

Water is an essential component of the composition; preferably water will be present in at least 70 wt % of the composition.

The frozen confection products of the invention may comprise various optional components.

Stabilisers that may be used include proteins such as gelatin; plant extrudates such as gum arabic, gum ghatti, gum karaya, gum tragacanth; seed gums such as locust bean gum, guar gum, psyyllium seed gum, quince seed gum or tamarind seed gum; seaweed extracts such as agar, alganates, carrageenan or furcelleran; pectins such as low methoxyl or high methoxyl-type pectins; cellulose derivatives such as sodium carboxymethyl cellulose, microcrystalline cellulose, methyl and methylethyl celluloses, or hydroxylpropyl and hydroxypropylmethyl celluloses; and microbial gums such as dextran, xanthan or β-1,3-glucan. Preferably, the stabiliser is selected from locust bean gum, kappa carrageenan, guar gum or mixtures thereof. Preferably the stabilisers are present at a level of 0.05-1 wt % of the composition.

In addition, the composition of the invention may contain flavouring and/or colouring. Typical flavourings include mint, vanilla, chocolate, coffee, or fruit flavours. Preferably, the flavouring or colouring will be present at a level of less than 1 wt % of the composition. Pieces of nut, chocolate, ginger, biscuit, fruit, fruit puree, or other ingredients or additives commonly added to ice cream or other ice confections may also be included. The term “fruit puree” as used herein means a homogeneous product which has been prepared from whole or peeled fruit, which has been pulped by a suitable physical process. The puree may or may not have had a portion of the water physically removed, may or may not have had sugars added and may or may not have been heat treated.

### EXAMPLES

In the following, compositions demonstration various facets of the invention were prepared. Properties of the compositions such as fat content, water content, overrun and protein content were determined as set forth below.

Methods for Determining Overrun

Determining Overrun at the Point of Manufacture

The density of the unaerated mix is determined by weighing a standard overrun cup of mix at approximately 4° C., subtracting the mass of the cup and dividing by the known volume of the cup (density=mass/volume). A minimum of three repeat measurements is taken. The density of the (aerated) ice cream is determined by repeating the procedure on the same overrun cup with freshly extruded ice cream (at approximately −2° C. to −7° C.). Again a minimum of three repeat measurements is taken. With a knowledge of the density of both unaerated mix and aerated ice cream, the overrun can be calculated using the equation given above.

Determining Overrun of a Finished Product

The density of a finished ice cream (or other aerated ice confection) product can also be estimated by making use of the Archimedes' principle as described in “A-level Physics, Third Edition, by R. Muncaster, Pub. Stanley Thornes Ltd., Cheltenham, 1989”.

First a sample of ice cream is weighed in air to determine its mass. Then the volume of the same sample is determined using the Archimedes' principle as described below. The sample of ice cream is held carefully in a beaker of chilled water just below the surface of the water by a fork (or a knife) inserted into the end of the product. The beaker is placed on a balance throughout the experiment and the increase in weight on immersing the product is recorded. By Archimedes' principle, the increase in weight is equal to the upthrust and hence weight of water displaced. Taking the density of water as 1 gcm⁻³, the weight of water displaced is used to determine the volume of water displaced and thus the volume of ice cream immersed in the beaker. From the mass and volume of the product, the density of the ice cream can be calculated. A minimum of three repeat measurements is taken.

The density of the unaerated mix can either be assumed to be 1.1 g/cm³ or can be estimated by melting the ice cream until the air-phase is lost and then determining the density in an overrun cup at 4° C. as described above. With a knowledge of the density of both unaerated mix and aerated ice cream, the overrun can be calculated using the equation on page 6.

A Method for Determining Fat Content

For the purposes of this method, the terms “fat” and “oil” are regarded as being one and the same, in terms of molecular composition. Fat (or oil) content can be determined by the “Weibul” acid hydrolysis procedure. This is a recognised BS Method (No.4401) Ref. Official, Standardised and Recommended Methods of Analysis SAC, 1973 2nd Ed. p 160. The sample is boiled with approximately 6M hydrochloric acid to release ‘bound’ fat and the digest is filtered through a double filter paper using filter aid. Fat was retained by the filter paper and aid. After washing and drying, the residue is extracted with light petroleum spirit using a Soxhlet extractor. Descriptions of the performance of the method and a comparison with other methods can be found in these references
a) Weibul, Staatsbled van het Koninkrijk Der Hederlander p1-16, 1919, No. 581.
b) W Stoldt, Z Undersuchung & Lebensmittel, 1937, 73. 329.
c) Nottbolm &, Baumann, Z Undersuchung & Lebensmittel 1931, 62. 164.
d) ISO 1143-1973
   A Method for Determining Protein Content

Protein content can be determined by measuring the nitrogen present in the sample. This can be done by using equipment that is manufactured for the purpose: the “Macro N” (Foss-Heraeus). In this procedure, the sample under test is completely burned at temperatures in excess of 1000° C. in the presence of oxygen. The resultant combustion gases are swept through a series of absorption tubes by a stream of carbon dioxide, this procedure removes unwanted gases, finally the carbon dioxide and nitrogen mixture are passed through a thermal conductivity detector where the nitrogen is quantified. Nitrogen content is converted to protein content using a conversion factor based on the average nitrogen of the amino acids found in particular foods.

A suitable conversion factor to use for analysing the protein content in ice confections that are made according to this invention is 6.25, although other conversion factors could be used—based on the particular protein source that is being analysed.

The procedure is published in the following article. Ian D Smith, Analytical Proceedings, 1991, 28. 320-324. “Evaluation of the Foss-Heraeus Macro N for the Determination of Nitrogen in a Wide Range of Foodstuffs, Ingredients and Biological Materials and Comparison with the Kjelfoss”.

A Method for Determining Water Content

The method involves the measurement of weight loss due to evaporation of water. A fan assisted, thermostatically controlled air oven is used at a temperature of 100° C. The procedure described is similar to Official and Standardised methods recommended by:
a) The Association of Official Agricultural Chemists USA, ‘Official Methods of Analysis’ 12th Edition, 1975,
b) The Fertiliser and Feedingstuffs Regulations HMSO, Statutory Inst. No 840, 1976.
c) ISO 1026-1982, ISO 1442-1973.

15-20 gram of dry sand and a small glass rod are placed in an aluminium foil cup. This assembly is weighed (=W1). A sample of melted ice cream (approximately 5 gram) is added to the cup and weighed again (=W2). The melted ice cream is then mixed into the sand with the glass rod. The cup is then placed on a steam bath and evaporated to dryness (takes 30 minutes); the sample is stirred with the rod throughout this procedure. The sample is then placed in an oven for 2.5 hours that has been pre-set at 100° C. The cup is then placed in a dessicator to cool before weighing (=W3).

Water content is given by:

$$\% Water w / w = \frac{W2 - W3}{W2 - W1} \times 100$$

Where: W1=Weight of cup (including sand and glass rod).
W2=Weight of cup+wet sample.
W3=Weight of cup+dried sample.

### EXAMPLE 1

### A Method for Producing Oil Bodies

A total of 1.7 kg of de-hulled sunflower seeds was ground in a food-processor until no large particles were present. The ground seeds were homogenised in two volumes of cold grinding buffer (0.6 M sucrose and 1.0 M NaCl) using a Waring blender (a commercial heavy duty blender) at low speed. The homogenate was filtered through a 500 μm pore size sieve to remove large particles and seed skins. After sieving, the homogenate was centrifuged at 10,000×g for 30 minutes at 4° C. in order to remove large particles, insoluble proteins and separate the oil bodies from the aqueous soluble seed proteins. The floating oil body layer was skimmed off by using a metal spatula and added to one volume of floating buffer (0.6 M sucrose).

After homogenisation in the Waring blender at low speed, the mixture was sieved through a 150 μm pore-size sieve to obtain an emulsion with oil bodies less than 150 μm in size. The homogenised oil bodies were centrifuged again as described above. The skimmed oil bodies were washed twice in one volume of floating buffer and after each wash step centrifuged as described. The final oil body preparation was placed in a sealed plastic container and stored at 4° C. until used.

Approximately 1 kg of oil body preparation was produced. This was determined to have a water content of approximately 35% using the method described above. Therefore the “dry” oil body content of the preparation was approximately 65% by weight. It is important to measure this for each oil body preparation so that it is known how much oil body is added to each mix (see below). When the method for producing oil bodies was repeated several times it was found that the water content in different oil body preparations varied slightly (between 30% and 40%). Therefore the “dry” oil body content varied between 60% and 70%.

### EXAMPLE 2

### A Method for Making an Aerated Ice Confection in a Shop or in a Small Manufacturing Unit

A mix was prepared with the following composition:

| Ingredient | Weight % |
|---|---|
| Sucrose | 12 |
| Locust Bean Gum | 0.35 |
| Kappa Carrageenan | 0.02 |
| Glucose Syrup 42DE | 8 |
| PGE 55* | 1 |
| Oil body preparation | 7.5 |
| (prepared as described in example 1)† | |
| Flavour | 0.1 |
| Colour | 0.05 |
| Water (de-ionised) | 70.98 |

*PGE 55 is polyglycerol ester 55 (having a melting point of 55° C.) available from Danisco
†Water content of this oil body preparation was approximately 35%. Therefore the oil body content in the mix was approximately 4.9% (7.5% × 0.65).

The mix was prepared by dissolving dry ingredients in water at 60-70° C. and then adding the oil body. The mix was heated in a stainless steel pan on a hot plate to 80° C. at which point the oil body preparation was dispersed in the mix using an. homogeniser (Silverson L4R), heated to 80° C. and Pasteurised. The mix was then cooled to approximately 4° C. by placing it in a chill store.

Aeration was carried out using a Hobart mixer (Hobart Corp. Model: N50 CE). 1-2 litres of the mix was whipped by setting the mixer on full speed. Approximately 100% overrun was achieved in less than 3 minutes. Overrun was determined with the overrun cup method as described above. The aerated mix was poured into stainless steel moulds and wooden sticks were inserted into the mix. The moulds were placed in a glycol bath at −18° C. until the mix was frozen.

After freezing, the moulds were immersed in warm water (25° C.-30° C.) to release the frozen products from the moulds. The products were put in packets and stored at −25° C. in a freezer.

### EXAMPLE 3

### A Method for Making an Aerated Ice Confection in a Factory

A mix was prepared with the following composition:

| Ingredient | Weight % |
|---|---|
| Sucrose | 18.0 |
| Guar gum | 0.3 |
| PGE 55* | 0.5 |
| Vanillin | 0.05 |
| Oil body preparation | 7.1 |
| (prepared as described in example 1)† | |
| Water | 74.05 |

*PGE 55 is polyglycerol ester 55 available from Danisco.
†Water content of this oil body preparation was approximately 31%. Therefore the oil body content in the mix was approximately 4.9% (7.1% × 0.69).

All the ingredients except the oil body were mixed together using a high shear mixer for approximately 5 minutes, the water being added at a temperature of approximately 80° C. The temperature of the mix was above 60° C. after mixing. The mix was passed through to a plate heat exchanger for Pasteurisation at 82° C. for 25 seconds. The mix was then cooled to approximately 4° C. in the plate heat exchanger and stored at approximately 4° C. overnight in churns in a chill store.

The mix was heated to 60° C.-70° C., then the oil body preparation was added, then the mix was heated to approximately 80° C. (to Pasteurise it) and dispersed using a homogeniser (Silverson L4R). The Pasteurised oil body mix was then cooled to approximately 4° C.

The oil body mix was re-homogenised (using the Silverson homogeniser) immediately prior to use, aerated and frozen in a Technohoy MF75 scraped surface heat exchanger fitted with a C29800 open dasher. The mix was extruded at a temperature of between −2° C. and −3.3° C. into plastic cups.

The overrun at extrusion was determined using the overrun cup method as described above. The overrun was found to be approximately 75%.

The products (in plastic cups) were then hardened in a blast freezer at −35° C. and stored at −25° C.

### EXAMPLE 4

### Analysis of Hardened Ice Confection

The hardened ice confection produced in Example 3 was analysed using the methods described above.

Results of the Analysis

| | |
|---|---|
| Fat content: | 4.1% |
| Protein content: | 0.6% |
| Overrun | 90% |
| | (estimate using the |
| | Archimedes' method) |
| Water content | 77% |

### EXAMPLE 5

### A Method for Making an Unaerated Ice Confection in a Shop or in a Small Manufacturing Unit

A mix was prepared with the following composition:

| Ingredient | Weight % |
|---|---|
| Sucrose | 18 |
| Guar Gum | 0.15 |
| Oil body preparation | 7.5% |
| (prepared as described in example 1)† | |
| Water (de-ionised) | 74.35 |

†Water content of this oil body preparation was approximately 35%. Therefore the oil body content in the mix was approximately 4.9% by weight.

The mix was prepared by dissolving dry ingredients in water at 60-70° C. and then adding the oil body. The mix was heated in a stainless steel pan on a hot plate to 80° C. Then the mix was placed in a food blender and blended on maximum power for 1 minute to disperse the oil body. The mix was then cooled to approximately 4° C. by placing it in a chill store. The mix was then poured into stainless steel moulds and wooden sticks were inserted into the mix. The moulds were placed in a glycol bath at −18° C. until the mix was frozen.

After freezing, the moulds were immersed in warm water (25° C.-30° C.) to release the frozen products from the moulds. The products were put in packets and stored at −25° C. in a freezer.

Examples 6-13 evaluate a number of aerating agents using the method for evaluating candidate aerating agents set out above. The oil body preparations were prepared according to Example 1. The overrun of the aerated mix was measured as a function of time using the method described above in the section entitled “Determining overrun at the point of manufacture”.

### EXAMPLE 6

### PGE-55 Added Before the Oil Body Preparation

PGE-55 is polyglycerol ester 55 available from Danisco.

| Ingredient | Weight % |
|---|---|
| Sucrose | 18 |
| Guar | 0.3 |
| PGE-55 | 0.5 |
| Oil body preparation | 7.7 |
| De-ionised water | 73.5 |

The water content of the oil body preparation was 35.3%. Therefore the oil body content in the mix was 7.7%×(1−0.353)=5.0%. The mass of the overrun cup was 409.1 g and the mass of a full cup of unaerated mix was 136.1 g.

| Time | Mass of full cup of | Mass of aerated | Overrun |
|---|---|---|---|
| (minutes) | aerated mix (g) | mix (g) | (%) |
| 0.5 | 529.6 | 120.5 | 12.9 |
| 1 | 524.3 | 115.2 | 18.1 |
| 1.5 | 525 | 115.9 | 17.4 |
| 2 | 518.8 | 109.7 | 24.1 |
| 3 | 515.8 | 106.7 | 27.6 |
| 4 | 512.5 | 103.4 | 31.6 |
| 6 | 514.2 | 105.1 | 29.5 |
| 8 | 513.5 | 104.4 | 30.4 |
| 10 | 510.2 | 101.1 | 34.6 |
| 12 | 503.3 | 94.2 | 44.5 |
| 14 | 504.7 | 95.6 | 42.4 |
| 16 | 505.4 | 96.3 | 41.3 |
| 18 | 503.4 | 94.3 | 44.3 |
| 20 | 501.9 | 92.8 | 46.7 |
| 24 | 497.7 | 88.6 | 53.6 |
| 32 | 495.2 | 86.1 | 58.1 |
| 42 | 494.1 | 85 | 60.1 |
| 50 | 496.2 | 87.1 | 56.3 |

### EXAMPLE 7

### PGE-55 Added After the Oil Body Preparation

| Ingredient | Weight % |
|---|---|
| Sucrose | 18 |
| Guar 0.3 | |
| PGE 55 | 0.5 |
| Oil body preparation | 8.1 |
| De-ionised water | 71.6 |
| De-ionised water (to dissolve PGE-55) | 1.5 |

The water content of the oil body preparation was 38%. Therefore the oil body content in the mix was 8.1%×(1−0.38)=5.0%. The mix was prepared using the method for evaluating candidate aerating agents set out above, except that PGE-55 was omitted from the initial heated mix. PGE-55 was instead dissolved in a portion of the de-ionised water (1.5%) and heated to 80° C. The PGE-55 solution was then cooled to approximately 4° C. by placing it in a chill store. The chilled PGE-55 solution was added to the chilled mix immediately prior to aeration. The mass of the overrun cup was 407.7 g and the mass of a full cup of unaerated mix was 130.8 g.

| Time | Mass of full cup of | Mass of aerated | Overrun |
|---|---|---|---|
| (minutes) | aerated mix (g) | mix (g) | (%) |
| 0.5 | 514.5 | 106.8 | 22.5 |
| 1 | 496.3 | 88.6 | 47.6 |
| 1.5 | 488 | 80.3 | 62.9 |
| 2 | 479.4 | 71.7 | 82.4 |
| 2.5 | 475.4 | 67.7 | 93.2 |
| 3 | 466.6 | 58.9 | 122.1 |

### EXAMPLE 8

### Mono-Di HP 40-1 (0.9%)

Mono-Di HP 40-1 is a mono-diglyceride made from edible, fully hydrogenated palm based oil available from Danisco.

| Ingredient | Weight % |
|---|---|
| Sucrose | 18 |
| Guar | 0.3 |
| Mono-Di HP 40-1 | 0.9 |
| Oil body preparation | 7.7 |
| Water | 73.1 |

The water content of the oil body preparation was 35.3%. Therefore the oil body content in the mix was 7.7%×(1−0.353)=5.0%. The mass of the overrun cup was 409.1 g and the mass of a full cup of unaerated mix was132.1 g.

| Time | Mass of full cup of | Mass of aerated | Overrun |
|---|---|---|---|
| (minutes) | aerated mix (g) | mix (g) | (%) |
| 0.5 | 524.9 | 115.8 | 14.1 |
| 1 | 514.1 | 105 | 25.8 |
| 1.5 | 518.7 | 109.6 | 20.5 |
| 2 | 513.5 | 104.4 | 26.5 |
| 2.5 | 516.0 | 106.9 | 23.6 |
| 3.5 | 516.8 | 107.7 | 22.7 |
| 5 | 513.9 | 104.8 | 26.0 |
| 7 | 512.6 | 103.5 | 27.6 |
| 10 | 510.4 | 101.3 | 30.4 |
| 15 | 512.2 | 103.1 | 28.1 |
| 20 | 513.3 | 104.2 | 26.8 |

### EXAMPLE 9

### Mono-Di HP 40-1 (0.3%)

| Ingredient | Weight % |
|---|---|
| Sucrose | 18 |
| Guar | 0.3 |
| Mono-Di HP 40-1 | 0.3 |
| Oil body preparation | 7.7 |
| Water | 73.7 |

The water content of the oil body preparation was 35.3%. Therefore the oil body content in the mix was 7.7%×(1−0.353)=5.0%. The mass of the overrun cup was 409.1 g and the mass of a full cup of unaerated mix was127.5 g.

| Time | Mass of full cup of | Mass of aerated | Overrun |
|---|---|---|---|
| (minutes) | aerated mix (g) | mix (g) | (%) |
| 0.5 | 525.9 | 116.8 | 9.2 |
| 1 | 524.9 | 115.8 | 10.1 |
| 2 | 518.0 | 108.9 | 17.1 |
| 4 | 517.7 | 108.6 | 17.4 |
| 6 | 518.1 | 109 | 17.0 |
| 8 | 519.8 | 110.7 | 15.2 |
| 10 | 514.9 | 105.8 | 20.5 |
| 12 | 521.3 | 112.2 | 13.6 |
| 14 | 520.4 | 111.3 | 14.6 |

### EXAMPLE 10

### Myverol 18-04 K (1%)

Myverol 18-04 K is a kosher approved distilled monoglyceride which is prepared from vegetable oils and fats available, and is available from Quest International.

| Ingredient | Weight % |
|---|---|
| Sucrose | 18 |
| Guar | 0.3 |
| Myverol 18-04 K | 1 |
| Oil body preparation | 7.8 |
| Water | 72.9 |

The water content of the oil body preparation was 36%. Therefore the oil body content in the mix was 7.8%×(1−0.36)=5.0%. The mass of the overrun cup was 407.4 g and the mass of a full cup of unaerated mix was127.3 g.

| Time | Mass of full cup of | Mass of aerated | Overrun |
|---|---|---|---|
| (minutes) | aerated mix (g) | mix (g) | (%) |
| 0.5 | 468.0 | 60.6 | 110.1 |

### EXAMPLE 11

### Myverol 18-04 K (0.3%)

| Ingredient | Weight % |
|---|---|
| Sucrose | 18 |
| Guar | 0.3 |
| Myverol 18-04 K 0.3 | |
| Oil body preparation | 7.7 |
| Water | 73.7 |

The water content of the oil body preparation was 36%. Therefore the oil body content in the mix was 7.8%×(1−0.36)=5.0%. The mass of the overrun cup was 409.1 g and the mass of a full cup of unaerated mix was132.2 g.

| Time | Mass of full cup of | Mass of aerated | Overrun |
|---|---|---|---|
| (minutes) | aerated mix (g) | mix (g) | (%) |
| 0.5 | 515.0 | 105.9 | 24.8 |
| 1 | 511.0 | 101.9 | 29.7 |
| 1.5 | 505.5 | 96.4 | 37.1 |
| 2 | 504.3 | 95.2 | 38.9 |
| 3 | 497.5 | 88.4 | 49.5 |
| 4 | 495.2 | 86.1 | 53.5 |
| 5 | 493.0 | 83.9 | 57.6 |
| 7 | 486.8 | 77.7 | 70.1 |
| 9 | 484.4 | 75.3 | 75.6 |
| 11 | 478.8 | 69.7 | 89.7 |
| 13 | 473.9 | 64.8 | 104.0 |

### EXAMPLE 12

### Myverol 18-04 K (0.1%)

| Ingredient | Weight % |
|---|---|
| Sucrose | 18 |
| Guar | 0.3 |
| Myverol 18-04 K 0.1 | |
| Oil body preparation | 7.7 |
| Water | 73.9 |

The water content of the oil body preparation was 35.1%. Therefore the oil body content in the mix was 7.7%×(1−0.351)=5.0%. The mass of the overrun cup was 409.1 g and the mass of a full cup of unaerated mix was127.5 g.

| Time | Mass of full cup of | Mass of aerated | Overrun |
|---|---|---|---|
| (minutes) | aerated mix (g) | mix (g) | (%) |
| 0.5 | 523.0 | 113.9 | 11.9 |
| 1 | 518.0 | 108.9 | 17.1 |
| 2 | 519.3 | 110.2 | 15.7 |
| 4 | 514.6 | 105.5 | 20.9 |
| 6 | 515.9 | 106.8 | 19.4 |
| 8 | 514.0 | 104.9 | 21.5 |
| 12 | 513.6 | 104.5 | 22.0 |
| 18 | 516.1 | 107.0 | 19.2 |

### EXAMPLE 13

### Versa-Whip 500 (0.5%)

Versa-Whip 500 is a food grade modified soy protein, available from Quest International.

| Ingredient | Weight % |
|---|---|
| Sucrose | 18 |
| Guar | 0.3 |
| Versa-Whip 500 | 0.5 |
| Oil body preparation | 7.7 |
| Water | 73.5 |

The water content of the oil body preparation was 35.3%. Therefore the oil body content in the mix was 7.7%×(1−0.353)=5.0%. The mass of the overrun cup was 407.4 g and the mass of a full cup of unaerated mix was131.4 g.

| Time | Mass of full cup of | Mass of aerated | Overrun |
|---|---|---|---|
| (minutes) | aerated mix (g) | mix (g) | (%) |
| 0.5 | 538.8 | 131.4 | 0.0 |
| 20 | 538.8 | 131.4 | 0.0 |

### EXAMPLE 14

### Preparation of an Iced Confection Using Myverol and Fruit Puree

| Ingredient | Weight % |
|---|---|
| Sucrose | 18 |
| Guar | 0.3 |
| Myverol 18-04 K | 0.3 |
| Banana puree (62% solids) | 40 |
| Banana flavour | 0.2 |
| Oil body preparation | 7.8 |
| Water | 33.4 |

The banana puree was obtained from SVZ International (www.svz.com)

The water content of the oil body preparation was 36%. Therefore the oil body content in the mix was 7.8%×(1−0.36)=5.0%. The mass of the overrun cup was 407.4 g and the mass of a full cup of unaerated mix was126.8 g. The mix was prepared and products were made as described in Example 2, except that the banana puree and banana flavour was added to the chilled mix just prior to aeration.

| Time | Mass of full cup of | Mass of aerated | Overrun |
|---|---|---|---|
| (minutes) | aerated mix (g) | mix (g) | (%) |
| 0.5 | 489.3 | 81.9 | 54.8 |
| 1 | 478.3 | 70.9 | 78.8 |
| 1.5 | 471.3 | 63.9 | 98.4 |
| 2 | 464.6 | 57.2 | 121.7 |

### Example 15

### Analysis of Protein and Fat Content of Ice Confections

Ice confections were prepared from the aerated mixes of examples 7, 8, 9, 11, 12, and 14 following the procedure described in Example 2. The fat content and protein content of the products were determined as described in the sections entitled “A method for determining fat content” and “A method for determining protein content” above. The results were as follows.

| | | Fat content | Protein content |
|---|---|---|---|
| Example | Aerating agent | (% w/w) | (% w/w) |
| 7 | 0.5% PGE | 3.9 | 0.6 |
| 8 | 0.9% HP-40 | 4.0 | 0.5 |
| 9 | 0.3% HP-40 | 3.7 | 0.4 |
| 11 | 0.3% Myverol | 3.7 | 0.6 |
| 12 | 0.1% Myverol | 3.6 | 0.5 |
| 14 | 0.3% Myverol | 4.0 | 1.4 |
| | (+ banana puree) | | |

### EXAMPLE 16

### Detection of Oleosin in an Iced Confection

Aerated and unaerated ice confections were prepared according to examples 3 and 5 respectively. The following procedure was used for both samples. In order to extract intact oil bodies, 1-2 g of the confection was placed in an eppendorf tube and allowed to melt. The sample was then centrifuged at 13,500 rpm for 5 minutes in a Microcentaur centrifuge. The resulting ‘fat pad’ on the surface of the sample was transferred into a fresh eppendorf tube.

In order to remove non-oleosin proteins (such as sunflower seed proteins and milk proteins) the samples were washed with urea, following the procedure of reference 3 of page 12. 1 ml of 9M urea was added to the fat pads, mixed by vortexing thoroughly and incubated in the fridge for 2 hours. The sample was centrifuged and the fat pad was skimmed off. Two further urea washes were performed.

In order to remove the fat from the intact oil bodies and to precipitate the oleosins, 1 ml of acetone chilled to −25° C. was added to the fat pad, and the sample was incubated on ice for 1 hour. The sample was centrifuged at 13500 rpm in a Microcentaur centrifuge. The precipitate was retained and the supernatant was discarded. Two further washes with chilled acetone were carried out. The pellet was left to air-dry overnight.

Samples were then prepared for SDS-PAGE. All reagents were used according to the manufacturer's instructions. 0.001 g of the dry powder was re-solubilised in 0.5 ml sample buffer (from Invitrogen), and incubated at room temperature for 30 minutes. The sample reducing agent (from Invitrogen) was then added and the sample was boiled for 2 minutes. 25 □l of the resulting oleosin sample solution was loaded into to each of 8 wells of a 10% bis-tris NUPAGE gel (also from Invitrogen). Precision Plus Protein Standards (from Bio-Rad) were used as molecular weight markers in another well. The gel was then run using MES running buffer.

Two lanes, one containing the molecular weight standards and the other the oleosin sample were cut off the gel and stained with colloidal coomassie blue, or Simply Blue Safestain (both from Invitrogen) in order to identify the location of the protein in the sample. A pair of strongly stained protein bands with apparent molecular weights of between 15 and 20 kD were observed, corresponding to the two oleosin isoforms.

The proteins from the remaining unstained lanes were further purified by eluting them from the gel. The area on the gel corresponding to the location of the oleosin was excised, and minced up in an eppendorf tube. 1 ml of 5 mM tris-HCl buffer at pH8 with 5 mM EDTA and 0.25% Tween-20 was added. The solution was vortexed thoroughly and then incubated on a shaker for 3 hours, with occasional vortexing. After spinning for 5 minutes at 13,500 rpm in a Microcentaur centrifuge the supernatant liquid was recovered. The gel was washed twice more with 1 ml of buffer. In order to precipitate the protein, chilled acetone was added to the combined supernatants, and the sample was incubated in a freezer overnight. The precipitate was pelleted by centrifugation at 4,000 rpm for 10 minutes and the supernatant discarded. The pellet was dried and resolubilised with 160 □l sample buffer, and then prepared and run on SDS-PAGE again.

The gel was stained as before. A small glass capillary tube was used to excise three spots from each protein band. These were placed in a 200 □l PCR type tube with just enough water to cover them, frozen and transported on dry ice to the sequencing facility.

Sequencing of the protein was carried out at the John Innes Centre Proteomics facility. Tryptic digests of the samples were prepared, followed by QToF amino acid sequencing carried out using a Micromass® Q-ToF 2 mass spectrometer. Searching for matches with published amino acid sequences was carried out using the Mascot search engine (available through Matrix Science, www.matrixscience.com) which uses mass spectrometry data to identify proteins from primary sequence databases. Details of the search parameters are listed below.
Database: SPtrEMBL sptrembl20031031 (1295042 sequences 413813148 residues)
Taxonomy: Viridiplantae (Green Plants) (140955 sequences)
Type of search: MS/MS Ion Search
Enzyme: Trypsin
Fixed modifications: Carbamidomethyl (C)
Variable modifications: Oxidation (M)
Mass values: Monoisotopic
Protein Mass: Unrestricted
Peptide Mass Tolerance: ±0.25 Da
Fragment Mass Tolerance: ±0.25 Da
Max Missed Cleavages: 2

Five peptides from each sample gave close matches to published oleosin sequences. This demonstrates that the proteins isolated both from the aerated ice cream type product (where milk proteins were also initially present) and from the unaerated water ice type product (where the oil bodies are the only source of protein) were oleosins.

1. An ice confection containing;
i) at least 2% by wt. fat;
ii) at least 10% by wt. of a sugar or sugars; and
iii) proteins present at a level of less than 2% by weight;
wherein some or all of the fat and protein are present as oil bodies.

2. The ice confection of claim 1 further comprising 0.05% to 1% by wt. of an aerating agent, wherein the overrun is at least 30%, preferably more than 50%.

3. The ice confection of claim 2, wherein the confection has an overrun of no more than 200%.

4. The ice confection of claim 2 wherein the confection has an overrun of between 75% and 150%.

5. The ice confection of claim 2 wherein the aerating agent is a polyglycerol ester of fatty acids.

6. The ice confection of claim 2 wherein the aerating agent comprises monoglycerides.

7. The ice confection of claim 1 wherein some of the protein is oleosin.

8. The ice confection of claim 7 wherein some of the protein is sunflower oleosin.

9. The ice confection product of claim 1 wherein the oil bodies are derived from a source selected from the group consisting of sunflower, rapeseed, soybean, oil palm, cotton seed, ground nut, castor, safflower, mustard, coriander, squash, linseed, brazil nut, jojoba, maize, sesame, chick pea, avocado, or any mixture thereof.

10. The ice confection of claim 9 wherein the oil bodies are derived from a source selected from the group consisting of sunflower, soybean, avocado or rapeseed or any mixture thereof.

11. The ice confection of claim 10 wherein the oil bodies are derived from sunflower.

12. The ice confection of claim 1 wherein the oil bodies are present at a level of 0.5% to 20% by weight of the ice confection.

13. The ice confection of claim 12 wherein the oil bodies are present at a level of 2% to 10% by weight of the ice confection.

14. A method for preparing an ice confection including the steps of;
a) preparing an oil body preparation;
b) mixing non-oil body components together at elevated temperature;
c) adding the oil body preparation;
d) pasteurisation;
e) cooling;
f) aeration; and
g) freezing the confection.

15. A method for preparing an ice confection according to claim 14 wherein, between steps e) and f) an aerated agent is added.
